(19) United States
(12) Patent Application Publication
(10) Pub. No.: US 2018/0149260 A1
(43) Pub. Date: May 31, 2018

(54) APPARATUS FOR ACTIVE THERMAL MANAGEMENT OF TRANSMISSION LUBRICANT

(71) Applicant: GM GLOBAL TECHNOLOGY OPERATIONS LLC, Detroit, MI (US)

(72) Inventors: Avinash Singh, Sterling Heights, MI (US); Mohammad A. Hotait, Rochester Hills, MI (US); Addison T. Solak, Macomb, MI (US); Jeffrey R. Kelly, Whittaker, MI (US)

(21) Appl. No.: 15/364,301

(22) Filed: Nov. 30, 2016

(51) Int. Cl. F16H 57/04; F01P 3/20

(52) U.S. Cl. CPC F16H 57/0413; F16H 57/0423; F01P 2060/045; F01P 3/20; F16H 57/0417

(57) ABSTRACT

An apparatus for active thermal management of transmission lubricant includes a transmission having a housing and a rotating gear. A baffle arrangement is disposed within the housing operative to shroud a portion of the rotating component and direct transmission lubricant flow through at least one route. A heat exchanger disposed in the at least one route is operative to transfer thermal energy from a heat source to the transmission lubricant.

### FIELD

Apparatuses consistent with exemplary embodiments relate to apparatuses for transmission lubrication systems. More particularly, apparatuses consistent with exemplary embodiments relate to an apparatus for active thermal management of transmission lubricant.

### BACKGROUND

The statements in this section merely provide background information related to the present disclosure and may or may not constitute prior art.

The use of transmission fluid at low temperatures has always meant slow transmission shifting, sluggish operation, and frustration. During the transfer of power in the transmission, a substantial percentage of the total energy losses are due to the transmission pumping automatic transmission fluid to the working components of the transmission.

Cold temperatures can cause conventional transmission fluids to increase in viscosity, causing a decrease in a transmission's efficiency. This efficiency decrease demands more energy from the engine to actuate all the parts that come into contact with the transmission fluid.

The consequence of increased demand for energy from the engine can have a direct negative impact on a vehicle's fuel economy. An apparatus to mitigate the negative impact that transmission fluids have on a transmission's efficiency at low temperatures may be beneficial to a vehicle's fuel economy.

### SUMMARY

One or more exemplary embodiments address the above issue by providing apparatuses for transmission lubrication systems. More particularly, apparatuses consistent with exemplary embodiments relate to an apparatus for active thermal management of transmission lubricant.

According to an aspect of an exemplary embodiment, an apparatus for active thermal management of transmission lubricant includes a transmission having a housing and a rotating component. Another aspect of the exemplary embodiment includes a baffle arrangement disposed within the housing operative to shroud a portion of the rotating component and direct transmission lubricant flow through at least one route. Still another aspect as according to the exemplary embodiment includes a heat exchanger disposed in the at least one route operative to transfer thermal energy from a heat source to the transmission lubricant.

In accordance with other aspects of the exemplary embodiment, a fluid flow control device is disposed in the at least one route operative to allow or prevent lubricant flow. In accordance with further aspects of the exemplary embodiment, wherein the fluid flow control device is passive actuator operative to actuate in response to a condition change. Still in accordance with aspects of the exemplary embodiment, wherein the condition change is a temperature change.

Yet another aspect of the exemplary embodiment allows fluid flow through the at least one route below a predetermined temperature threshold. And another aspect of the exemplary embodiment wherein the heat source is an engine coolant system. Still another aspect of the exemplary embodiment wherein the heat exchanger includes at least one tubular branch for allowing thermal energy transfer between engine coolant and the transmission lubricant. And another aspect wherein the heat exchanger includes a maximum amount of tubular branches attainable in the at least one route.

According to another aspect of the exemplary embodiment wherein the tubular branches are formed to have maximum surface area for maximum thermal energy transfer between engine coolant and the transmission lubricant.

### BRIEF DESCRIPTION OF THE DRAWINGS

The present exemplary embodiments will be better understood from the description as set forth hereinafter, with reference to the accompanying drawings, in which:

FIG. 1 is an illustration of a powertrain of a vehicle in accordance with an aspect of the exemplary embodiment;

FIG. 1a is an illustration of a FWD transmission transfer case in accordance with aspects of an exemplary embodiment;

FIG. 2 is an illustration of an apparatus for active thermal management of transmission lubricant in accordance with an exemplary embodiment;

FIG. 3 is an illustration of an interior view of the baffle having at least one route for directing transmission lubricant flow to a heat exchanger in accordance with aspects of the exemplary embodiment; and

FIG. 4 is an illustration of an interior view of the apparatus for active thermal management of transmission lubricant with engine coolant flowing through the heat exchanger in accordance with aspects of the exemplary embodiment.

### DETAILED DESCRIPTION OF THE INVENTION

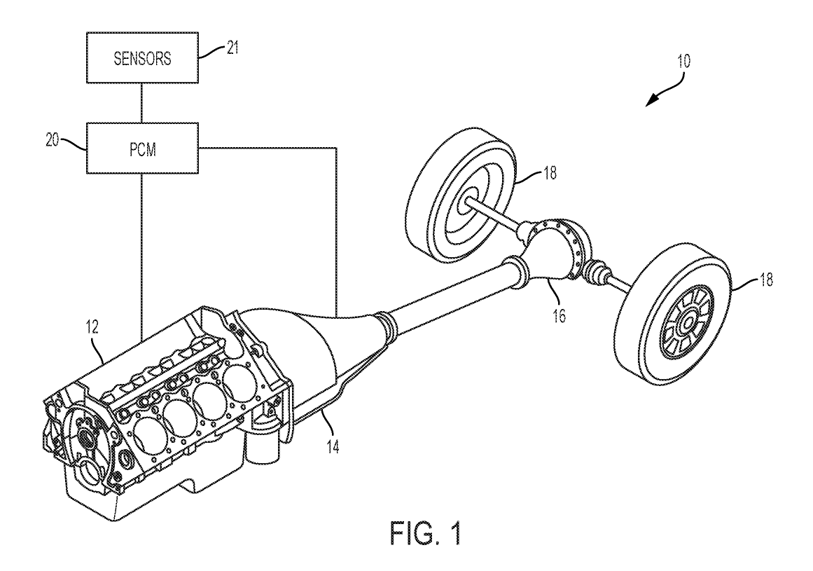

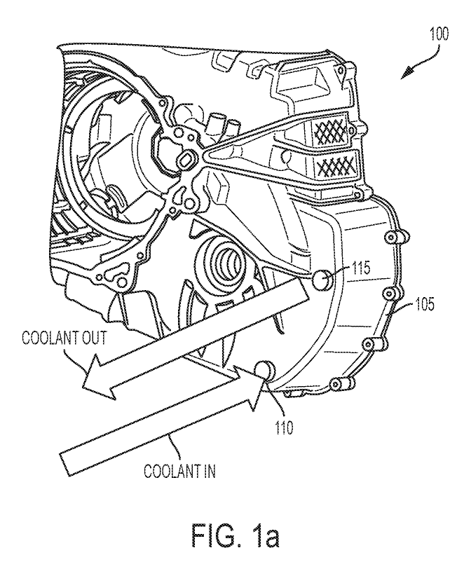

The following description is merely exemplary in nature and is not intended to limit the present disclosure, application, or uses thereof. FIG. 1 provides an illustration of a powertrain 10 of a vehicle in accordance with an aspect of the exemplary embodiment in accordance with aspects of an exemplary embodiment. The powertrain 10 includes an engine 12, a transmission 14 (e.g., FWD, RWD, automatic, continuously variable, dual clutch or manual), a driveshaft and rear differential 16, drive wheels 18, and a powertrain control module 20 (PCM). Sensors 21 are in communication with the PCM 20 and can include an engine coolant temperature sensor for measuring the temperature of the engine coolant, and a transmission fluid temperature sensor to monitor the temperature of the transmission fluid. The sensors 21 can then provide that information to the PCM 20.

The PCM 20 operates as the “brain” of a vehicle and controls a plurality of actuators on an internal combustion engine to ensure optimal engine performance. The PCM 20 is generally a combined control unit, consisting of an engine control unit (ECU) and a transmission control unit (TCU).

The engine 12 is an internal combustion engine that supplies a driving torque to the transmission 14. Traditionally, an internal combustion engine is identified by the number of cylinders it includes and in what configuration the cylinders are arranged. The engine 12 shown is a V8 configured engine 12 as the engine 12 includes eight cylinders arranged in a “V” configuration. The transmission 14, capable of several forward gear ratios, in turn delivers torque to the driveshaft and rear differential 16 and drive wheels 18.

It is appreciated that from a cold start, most vehicles will take approximately several minutes for the engine coolant temperature to become hot while it could take substantially longer for the transmission fluid temperature to heat up under the same conditions. When cold, transmission fluids can thicken and cause elongated and hard shifts causing a decrease in a transmission's efficiency until the fluid has warmed up enough to flow properly. This efficiency decrease demands more energy from the engine to actuate all the parts that come into contact with the transmission fluid. Increased demand for energy from the engine requires increased need for fuel which could affect the vehicle's fuel economy.

Referring now to FIG. 1a, an illustration of a FWD transmission transfer case 100 in accordance with aspects of an exemplary embodiment of an apparatus for active thermal management of a transmission lubricant is provided. The transfer case 100 includes a housing 105 having a coolant inlet 110 and a coolant outlet 115 for allowing engine coolant to flow through the transfer case 105 in accordance with aspects of the exemplary embodiment. It is appreciated that the exemplary embodiment is in reference to a FWD transmission system but the disclosed concept is applicable to other transmission systems (e.g. automatic, CVT, DCT, RWD, or manual) in general which are intended to be within the disclosed concept.

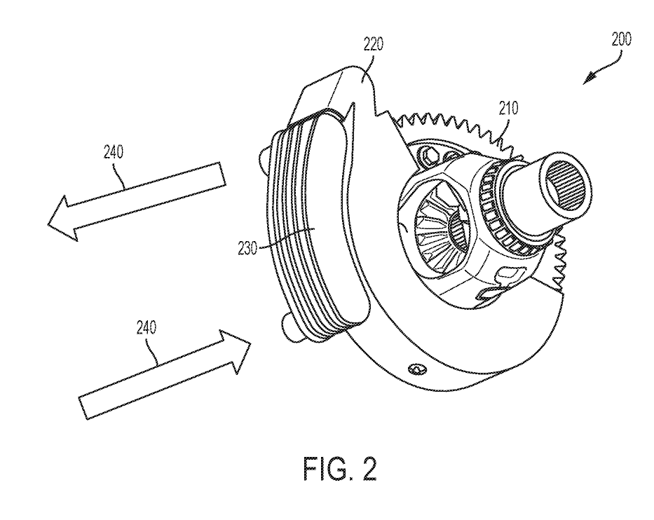

FIG. 2 is an illustration of an apparatus 200 for active thermal management of a transmission lubricant. The apparatus 200 includes a rotating component, e.g., a final differential ring gear or any other rotating component within a transmission that can be leveraged to force the directional flow of lubricant oil, 210 having a portion thereof shrouded by a baffle 220. The baffle 220 is operative to direct transmission lubricant flow being forced by a rotation of the rotating component 210 the through at least one route such that the transmission lubricant passes over and through spaces formed between portions of a heat exchanger 230. It is appreciated that the rotational direction of the rotating component 210 may be either clockwise or counter-clockwise to force lubricant flow through an appropriate baffle arrangement in accordance with the exemplary embodiment.

The heat exchanger 230 is operative to receive engine coolant 240 from the engine coolant system through a fluid transfer system (not shown) such that engine coolant 240 is received into the coolant inlet 110, through the interior portions of the heat exchanger 230, and out through the coolant outlet 115 for return to the engine coolant system (not shown).

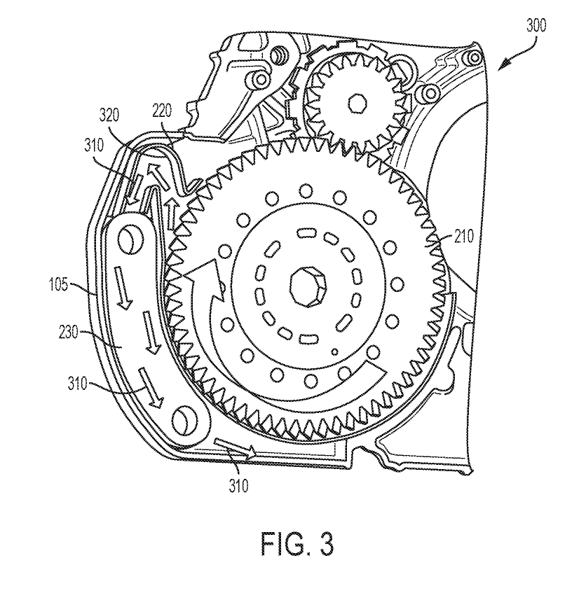

Referring now to FIG. 3, an illustration 300 of an interior view of the transfer case housing 105 and the baffle 220 having at least one route 320 for directing transmission lubricant flow 310 to a heat exchanger 230. As the final differential ring gear 210 spins in a clockwise rotation, it forces transmission lubricant 310 through the at least one route 320 of the baffle 220. The transmission lubricant flow 310 passes over the exterior surface(s) of the heat exchanger 230 and then returns to a transmission fluid sump (not shown) in accordance with aspects of the exemplary embodiment.

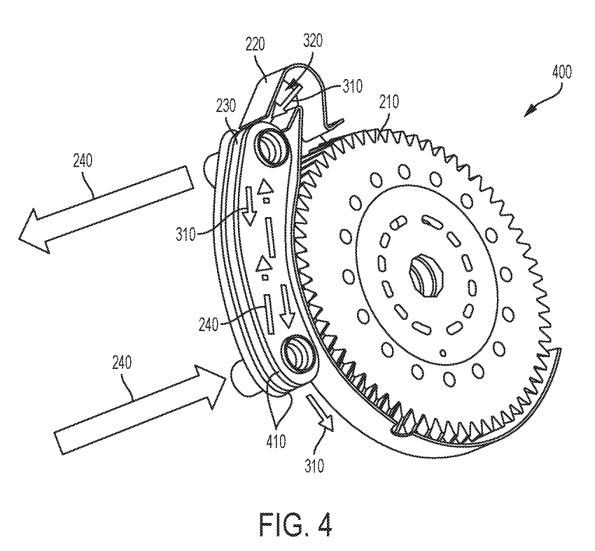

FIG. 4 is another illustration of an interior view of the apparatus 400 for active thermal management of transmission lubricant 310 with engine coolant 240 flowing through the heat exchanger in accordance with aspects of the exemplary embodiment. The final differential ring gear 210 agitates the transmission lubricant 310 and forces it to flow through the at least one route 320 of the baffle 220. As such, heat from the engine coolant 240 flowing through the interior of the heat exchanger 230 is transferred to the transmission lubricant flow 310 as it passes over and through spaces formed between portions 410 of the heat exchanger 230 in accordance with aspects of the exemplary embodiment is provided.

The heat exchanger 230 includes at least one tubular branch 410 for allowing thermal energy transfer between engine coolant 240 and the transmission lubricant 310. In accordance with aspects of the exemplary embodiment, the heat exchanger 230 includes a maximum amount of tubular branches 410 attainable within packaging limitations of the at least one route 320. The tubular branches 410 are formed to have maximum surface area for maximum thermal energy transfer between engine coolant 240 and the transmission lubricant 310. Heating the transmission lubricant 310 faster from a vehicle cold start condition through the use of the heat transfer method according to the exemplary embodiment may help mitigate the negative impact that cold transmission fluids have on a transmission's efficiency at low temperatures which may be beneficial to a vehicle's fuel economy.

It may be desirable to allow heating of the transmission lubricant as according to the exemplary embodiment only when it is below a certain temperature. In accordance with further aspects, a fluid flow control device (not shown) is disposed at an inlet of the at least one route 320 and is operative to allow or prevent transmission lubricant 310 flow to pass. In the exemplary embodiment, the fluid flow control device is a passive or active actuator operative to actuate in response to a condition change. The condition change may be a temperature change wherein the passive actuator allows transmission lubricant 310 to flow through the at least one route 320 below a predetermined temperature threshold but prevents the flow when the temperature rises above the predetermined threshold.

The description of the invention is merely exemplary in nature and variations that do not depart from the gist of the invention are intended to be within the scope of the invention. Such variations are not to be regarded as a departure from the spirit and scope of the invention.

What is claimed is:

1. An apparatus for active thermal management of transmission lubricant comprising:
a transmission having a housing and a rotating component;
a baffle arrangement disposed within the housing operative to shroud a portion of rotating component and direct transmission lubricant flow through at least one route; and
a heat exchanger disposed in the at least one route operative to transfer thermal energy from a heat source to the transmission lubricant.

2. The apparatus of claim 1 further comprising a fluid flow control device disposed at an inlet of the at least one route operative to allow or prevent transmission lubricant flow to pass.

3. The apparatus of claim 2 wherein the fluid flow control device is a passive actuator operative to actuate in response to a condition change.

4. The apparatus of claim 3 wherein the condition change is a temperature change.

5. The apparatus of claim 4 wherein the passive device allows transmission lubricant to flow through the at least one route below a predetermined temperature threshold.

6. The apparatus of claim 1 wherein the heat source is an engine coolant system.

7. The apparatus of claim 1 wherein the heat exchanger includes at least one tubular branch for allowing thermal energy transfer between engine coolant and the transmission lubricant.

8. The apparatus of claim 7 wherein the heat exchanger includes a maximum amount of tubular branches attainable within packaging limitations of the at least one route.

9. The apparatus of claim 8 wherein the tubular branches are formed to have maximum surface area for maximum thermal energy transfer between engine coolant and the transmission lubricant.

10. An apparatus for active thermal management of transmission lubricant comprising:
a transmission having a housing and a rotating component;
a baffle arrangement disposed within the housing operative to shroud a portion of the rotating component and direct transmission lubricant flow through at least one route;
a fluid flow control device disposed in the at least one route operative to allow or prevent lubricant flow; and
a heat exchanger disposed in the at least one route operative to transfer thermal energy from a heat source to the transmission lubricant.

11. The apparatus of claim 10 wherein the fluid flow control device is passive actuator operative to actuate in response to a condition change.

12. The apparatus of claim 11 wherein the condition change is a temperature change.

13. The apparatus of claim 12 wherein the passive device prevents fluid flow through the at least one route above a predetermined temperature threshold.

14. The apparatus of claim 10 wherein the heat source is an engine coolant system.

15. The apparatus of claim 10 wherein the heat exchanger includes at least one tubular branch for allowing thermal energy transfer between engine coolant and the transmission lubricant.

16. The apparatus of claim 15 wherein the heat exchanger includes a maximum amount of tubular branches attainable in the at least one route.

17. The apparatus of claim 16 wherein the tubular branches are formed to have maximum surface area for maximum thermal energy transfer between engine coolant and the transmission lubricant.
